(19) United States
(12) Patent Application Publication
(10) Pub. No.: US 2009/0319834 A1
(43) Pub. Date: Dec. 24, 2009

(54) COMPUTER-READABLE STORAGE MEDIUM STORING STORAGE MANAGEMENT PROGRAM, STORAGE MANAGEMENT METHOD,AND STORAGE MANAGEMENT APPARATUS

(75) Inventors: Kazutaka Ogihara, Kawasaki (JP); Yasuo Noguchi, Kawasaki (JP); Yoshihiro Tsuchiya, Kawasaki (JP); Masahisa Tamura, Kawasaki (JP); Tetsutaro Maruyama, Kawasaki (JP); Kazuichi Oe, Kawasaki (JP); Takashi Watanabe, Kawasaki (JP); Tatsuo Kumano, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/551,104

(22) Filed: Aug. 31, 2009

Related U.S. Application Data
(63) Continuation of application No. PCT/JP2007/054781, filed on Mar. 12, 2007.

(51) Int. Cl. G06F 11/28

(52) U.S. Cl. 714/42; 714/E11.178

(57) ABSTRACT

A storage management apparatus that performs a read/write check on each of a plurality of data-storing areas of a storage device, and is formed by a storage node that performs reading/writing of the data in the storage device. A computer determines whether or not the data exits, by referring to a flag provided in each data-storing area. The computer performs only an operation of writing the data into the data-storing area in which the data does not exist, and perform operations of reading and writing the data from and into the data-storing area in which the data exists.

This application is a continuing application, filed under 35 U.S.C. § 111(a), of International Application PCT/JP2007/054781, filed Mar. 12, 2007.

### FIELD

The embodiment discussed herein is related to a computer-readable storage medium storing a storage management program, a storage management method, and a storage management apparatus.

### BACKGROUND

In a disk storage unit, a defective portion referred to as a bad block (bad sector) is generated by various causes in an area in which data is stored. If a bad block is generated, the data stored in the block cannot be read, and hence a volume check is performed. In the volume check, a read/write in the entire disk is performed so as to find a bad block, reporting the defective portion, and replacing the block by an alternative area. After the operation is started, it is confirmed whether or not the data can be read, and if the data can be read, the data is actually read and written. A control method for facilitating data management after carrying out the above-mentioned check is known (see e.g. Japanese Laid-open Patent Publication No. 2005-293119).

By the way, in an area in which effective data is not stored, it is only necessary to write without reading. However, in the conventional method, also in an area in which effective data is not stored, the process is carried out without confirming the existence of data, assuming that there is always effective data. Therefore, this causes a problem that the processing time is long, and the processing load increases.

### SUMMARY

According to an aspect of the invention, there is provided a computer-readable storage medium storing a storage management program for performing a read/write check on each of a plurality of data-storing areas of a storage device. The storage management program causes the computer which is formed by a storage node that performs reading/writing of the data in the storage device to function as a data-checking unit configured to determine whether or not the data exits, by referring to a flag provided in each data-storing area and a data-reading/writing unit configured to perform only an operation of writing the data into the data-storing area in which the data does not exist, and perform operations of reading and writing the data from and into the data-storing area in which the data exists.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWING(S)

FIG. 1 schematically illustrates the present invention;

FIG. 2 illustrates an example of the configuration of a distributed storage system according to an embodiment;

FIG. 3 illustrates an example of a hardware configuration of a storage node used in the present embodiment;

FIG. 4 illustrates a data structure of a logical volume;

FIG. 5 illustrates a configuration of a slice;

FIG. 6 is functional block diagram of devices of the distributed storage system;

FIG. 7 illustrates an example of a data structure of slice management information;

FIG. 8 illustrates an example of a data structure of a slice management information group-storing section;

FIG. 9 is a flowchart of a media check process based on a media check method A;

FIG. 10 is a flowchart of a media check process for a data-stored slice;

FIG. 11 is a flowchart of a media check process for a data-free slice;

FIG. 12 is a flowchart of a media check process based on a media check method B, which is executed by the control node; and

FIG. 13 is a flowchart of a media check process executed by the storage node which has been notified.

### DESCRIPTION OF EMBODIMENT(S)

Embodiments of the present invention will be explained below with reference to the accompanying drawings, wherein like reference numerals refer to like elements throughout.

First, a description will be given of an outline of the present invention, and then a description will be given of the embodiment.

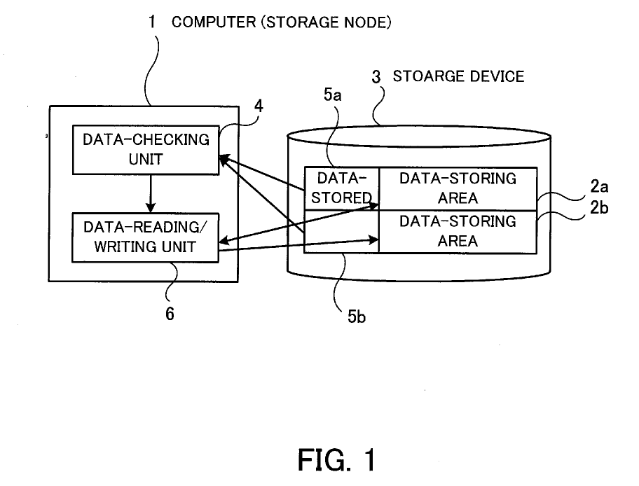

FIG. 1 schematically illustrates the present invention.

A computer 1 forms a storage node which reads and writes data in a storage device 3.

The computer 1 includes a data-checking unit 4 and a data-reading/writing unit 6.

The data-checking unit 4 and the data-reading/writing unit 6 operate at the time of a read/write check (volume check).

The data-checking unit 4 determines whether or not data exists by referring to each of flags 5a and 5b which are set for a plurality of storage areas 2a and 2b for storing data in the storage device 3. The data stored in each data storage area is data externally received by the computer 1 together with a writing request. When the data is written into the data storage area 2a or 2b, the computer 1 sets the associated flag 5a, 5b to “written”. In FIG. 1, data is stored only in the data storage area 2a.

The data-reading/writing unit 6 refers to information received from the data-checking unit 4, and does not perform a read operation on the data storage area 2b in which no data exists. That is, the data-reading/writing unit 6 performs only a write operation on the data storage area 2b storing no data.

According to the above-described storage management program, it is determined by the data-checking unit 4 whether or not the data exists by referring to the flags 5a and 5b set for the data storage areas 2a and 2b, respectively. The data read operation is not performed by the data-reading/writing unit 6 on the data storage area 2b in which no data exists.

Embodiments of the present invention will be described below.

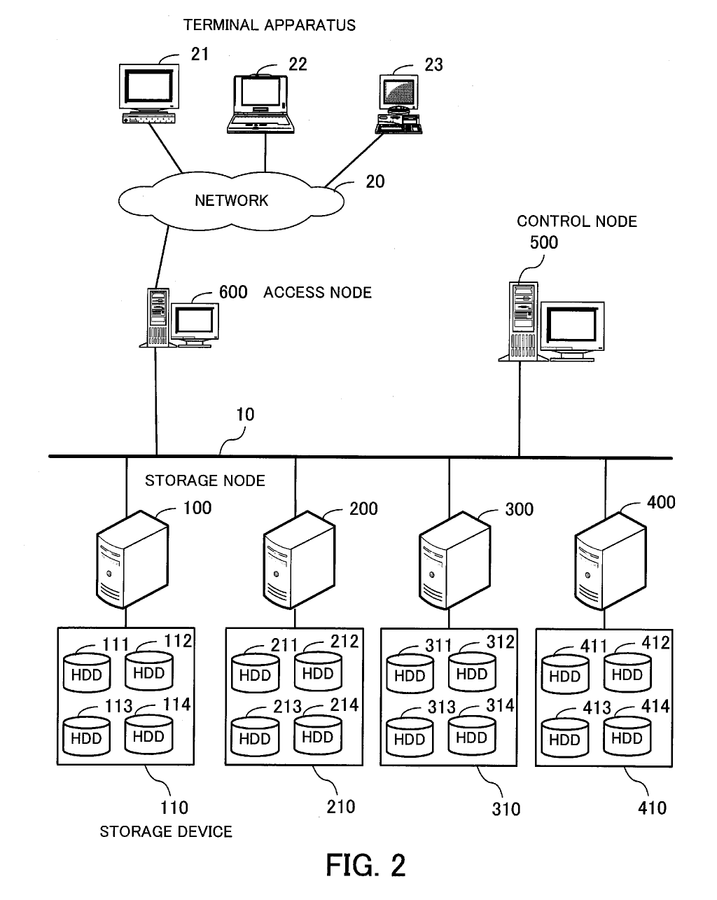

FIG. 2 illustrates an example of the configuration of a distributed storage system according to the present embodiment.

In the present embodiment, a plurality of storage nodes 100, 200, 300, and 400, a control node 500, and an access node 600 are connected via a network 10. Storage devices 110, 210, 310, and 410 are connected to the storage nodes 100, 200, 300, and 400, respectively.

A plurality of hard disk devices (HDD) 111, 112, 113, and 114 are mounted in the storage device 110. A plurality of HDDs 211, 212, 213, and 214 are mounted in the storage device 210. A plurality of HDDs 311, 312, 313, and 314 are mounted in the storage device 310. A plurality of HDDs 411, 412, 413, and 414 are mounted in the storage device 410. Each of the storage devices 110, 210, 310, and 410 is a RAID system using the HDDs integrated therein. In the present embodiment, each of the storage devices 110, 210, 310, and 410 provides a disk management service of RAID 5.

The storage nodes 100, 200, 300, and 400 are computers based on an architecture referred to as e.g. IA (Intel Architecture). The storage nodes 100, 200, 300, and 400 manage data stored in the connected storage devices 110, 210, 310, and 410, and provide the managed data to terminal apparatuses 21, 22, and 23 via the network 10. Further, the storage nodes 100, 200, 300, and 400 manage data having redundancy. That is, the same data is managed by at least two storage nodes.

Further, the storage nodes 100, 200, 300, and 400 carries out a duplexed maintenance process for checking the consistency of the duplexed data. The storage nodes 100, 200, 300, and 400 may carry out the duplexed maintenance process based on determination by each of them, or by an instruction externally received. In the present embodiment, the duplexed maintenance process is carried out in response to an instruction issued from the control node 500. The duplexed maintenance process is hereinafter referred to as the patrol.

In the patrol, the storage nodes storing the respective duplexed data are communicated with each other, and hence the consistency of the data having redundancy is checked. At that time, if a defect is detected in the data managed by one storage node, the data is recovered by using the associated data stored in the other storage node.

The control node 500 manages the storage nodes 100, 200, 300, and 400. For example, the control node 500 outputs a patrol instruction to each of the storage nodes 100, 200, 300, and 400 at a predetermined timing.

The plurality of the terminal apparatuses 21, 22, and 23 are connected to the access node 600 via a network 20. The access node 600 recognizes each data storage area managed by each of the storage nodes 100, 200, 300, and 400, and accesses the data stored in each of the storage nodes 100, 200, 300, and 400, in response to a request from any of the terminal apparatuses 21, 22 and 23.

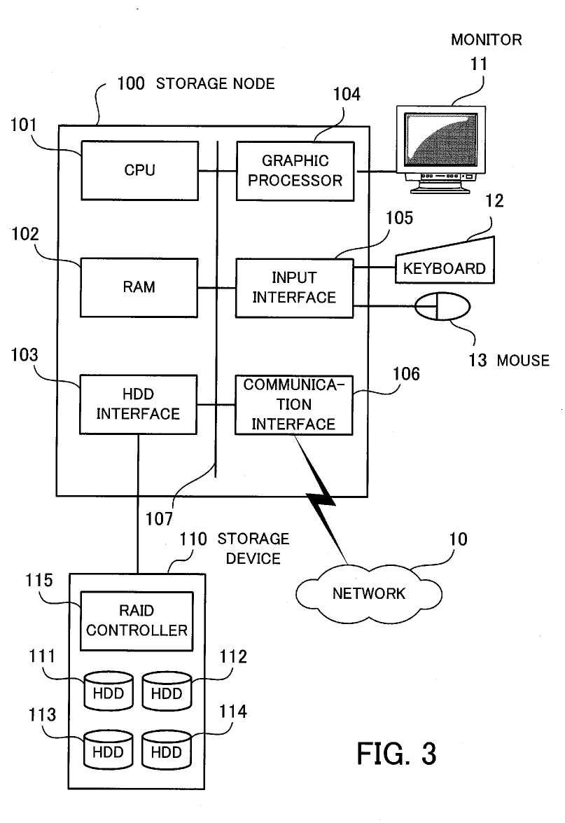

FIG. 3 illustrates an example of a hardware configuration of the storage node used in the present embodiment.

The entire storage node 100 is controlled by a CPU (Central Processing Unit) 101. A RAM (Random Access Memory) 102, an HDD interface 103, a graphic processor 104, an input interface 105, and a communication interface 106 are connected to the CPU 101 via a bus 107.

The RAM 102 temporarily stores at least part of a program of an OS (Operating System) and application programs which the CPU 101 is caused to execute. Further, the RAM 102 stores various data required by the CPU 101 for processing.

The storage device 110 is connected to the HDD interface 103. The HDD interface 103 communicates with a RAID controller 115 built into the storage device 110 to input and output data to the storage device 110. The RAID controller 115 in the storage device 110 has the functions of RAID0 to RAID5, and collectively manages the plurality of HDDs 111 to 114 as one hard disk.

A monitor 11 is connected to the graphic processor 104. The graphic processor 104 displays images on a screen of the monitor 11 according to commands from the CPU 101. A keyboard 12 and a mouse 13 are connected to the input interface 105. The input interface 105 transmits signals delivered from the keyboard 12 or the mouse 13 to the CPU 101 via the bus 107.

The communication interface 106 is connected to the network 10, and exchanges data with other computers via the network 10.

With the hardware configuration described above, it is possible to realize processing functions of the present embodiment. Although FIG. 3 illustrates the hardware configuration of the storage node 100 and the storage device 110, the other storage nodes 200, 300, and 400, and the other storage devices 210, 310, and 410 can each be realized by a similar hardware configuration.

Further, the control node 500, the access node 600, and the terminal apparatuses 21 to 23 can each be realized by a similar hardware configuration to a combination of the storage node 100 and the storage device 110. However, in the control node 500, the access node 600, and the terminal apparatuses 21 to 23, an individual HDD may be connected not to a RAID system such as the storage device 110 but to a single HDD controller,

As shown in FIG. 2, the plurality of storage nodes 100, 200, 300, and 400 are connected to the network 10, and each of the storage nodes 100, 200, 300, and 400 communicates with the other storage nodes. This distributed storage system serves as a virtual volume (hereinafter referred to as “the logical volume”) for the terminal apparatuses 21 to 23.

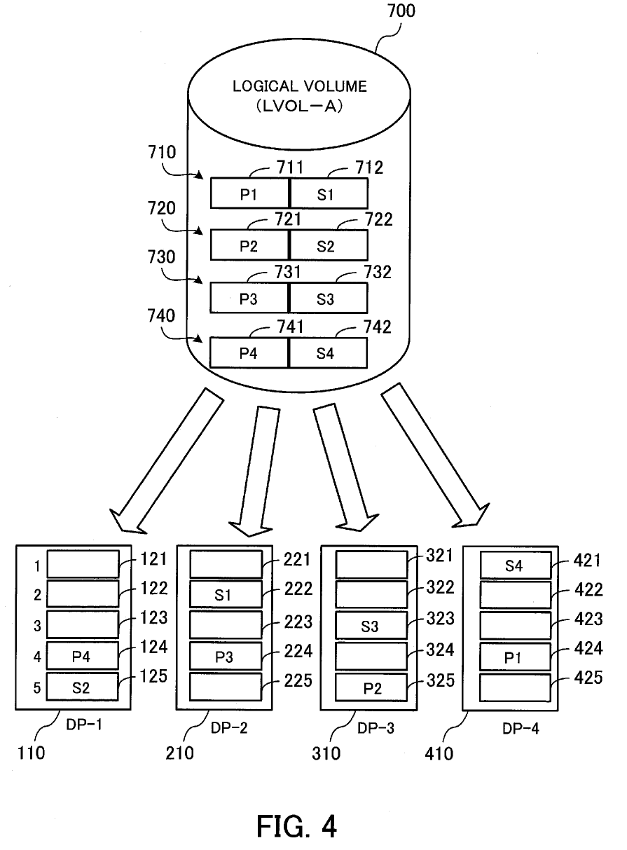

FIG. 4 illustrates data structure of the logical volume.

An identifier “LVOL-A” (logical volume identifier) is given to a logical volume 700. Further, node identifiers “DP-1”, “DP-2”, “DP-3”, and “DP-4” are given to four storage devices 110, 210, 310 and 410 which are connected to each other via the network, for identification.

A logical disk of the RAID 5 is constructed in each of the storage devices 110, 210, 310 and 410 included in the respective storage nodes 100, 200, 300, and 400. The logical disk is divided into 5 slices, and managed in each of the storage nodes.

In the illustrated example in FIG. 4, the storage area in the storage device 110 is divided into 5 slices 121 to 125. The storage area in the storage device 210 is divided into 5 slices 221 to 225. The storage area in the storage device 310 is divided into 5 slices 321 to 325. The storage area in the storage device 410 is divided into 5 slices 421 to 425.

The logical volume 700 is formed by units of segments 710, 720, 730, and 740. The storage capacity of each of the segments 710, 720, 730, and 740 is same as that of a slice which is a unit of management in the storage devices 110, 210, 310, and 410. For example, if the storage capacity of the slice is 1 gigabyte, the storage capacity of the segment is also 1 gigabyte. The storage capacity of the logical volume 700 is equal to an integral multiple of a storage capacity per segment. For example, if the storage capacity of the segment is 1 gigabyte, the storage capacity of the logical volume 700 is 4 gigabytes.

The segments 710, 720, 730, and 740 are formed by respective pairs (slice pairs) of primary slices 711, 721, 731, and 741, and secondary slices 712, 722, 732, and 742. Two slices which belong to one segment belong to different storage nodes, respectively. In each of areas for managing respective slices, there is stored a flag storing a value indicative of a primary slice or a secondary slice, in addition to a logical volume identifier, segment information, and information on a slice which forms the same segment.

In the illustrated example in FIG. 4, each slice identifier is represented by a combination of an alphabet “P” or “S”, and a number. “P” represents a primary slice. “S” represents a secondary slice. The number following the alphabet represents a position of a segment in a segment sequence. For example, the primary slice associated with the first segment 710 is indicated by “P1”, while the secondary slice associated with the same is indicated by “S1”.

Each primary slice and each secondary slice of the logical volume 700 having such a configuration are associated with any one of the slices in the storage devices 110, 210, 310, and 410. For example, the primary slice 711 of the segment 710 is associated with the slice 424 in the storage device 410, and the secondary slice 712 is associated with the slice 222 in the storage device 210.

Then, each of the storage devices 110, 210, 310, and 410 stores data of the primary slice or the secondary slice associated with each device's own slice.

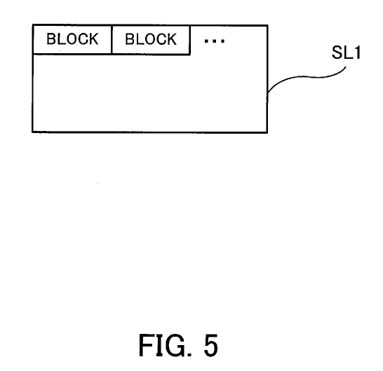

FIG. 5 illustrates the configuration of a slice.

A slice SL1 shown in FIG. 5 includes a plurality of blocks. Each block has a capacity of e.g. about 512 B (bytes). The read/write of data is performed on each block. That is, the read/write of data is performed for associated blocks of a slice as a storage unit of distributed data, on a block-by-block basis.

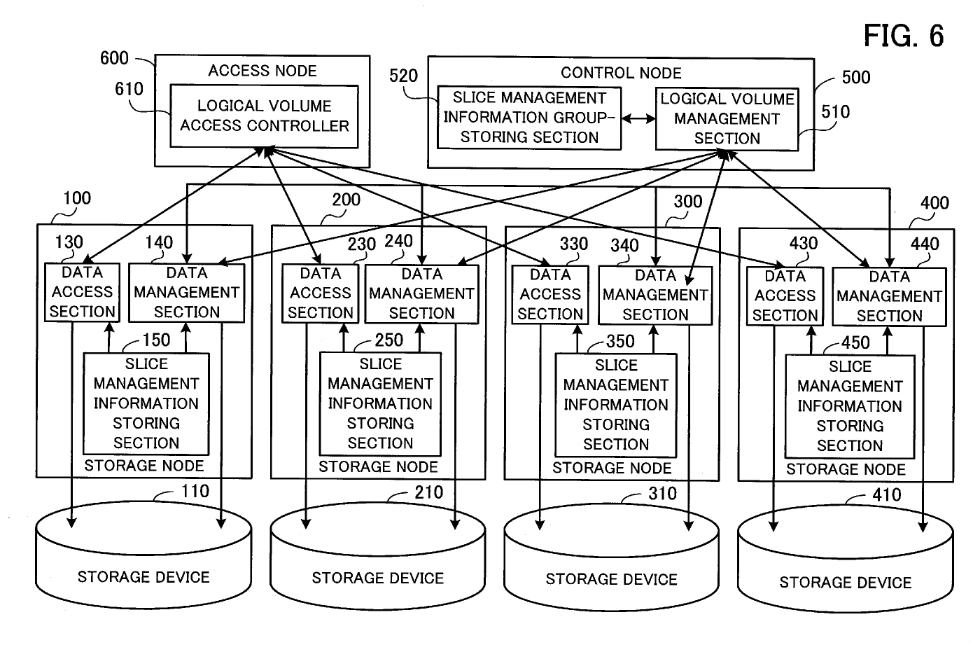

FIG. 6 is a functional block diagram of the devices of the distributed storage system.

The access node 600 includes a logical volume access controller 610. In response to an access request from any of the terminal apparatuses 21, 22, and 23 which specifies data in the logical volume 700, the logical volume access controller 610 accesses data stored in a storage node which manages the associated data. More specifically, the logical volume access controller 610 stores the correspondence between the primary slice or secondary slice of each segment of the logical volume 700 and each of slices in the storage devices 110, 210, 310, and 410. Then, if the logical volume access controller 610 receives an access request for accessing data in a segment from any of the terminal apparatuses 21, 22, and 23, the logical volume access controller 610 accesses data stored in one of the storage devices including the slice associated with the primary slice of the corresponding segment.

The control node 500 includes a logical volume management section 510 and a slice management information group-storing section 520.

The logical volume management section 510 manages the slices in the storage devices 110, 210, 310, and 410 included in the storage nodes 100, 200, 300, and 400, respectively. For example, when the system is started, the logical volume management section 510 transmits a slice management information acquisition request to the storage nodes 100, 200, 300, and 400. Then, the logical volume management section 510 stores slice management information returned in response to the slice management information acquisition request in the slice management information group-storing section 520.

Further, the logical volume management section 510 manages timing for carrying out the patrol for each segment in the logical volume 700. The patrol is carried out at predetermined time intervals, or at a time scheduled in advance. Further, by monitoring load on the distributed storage system, it is also possible to carry out the patrol at a time when the load is small. When it is time to carry out the patrol, the logical volume management section 510 transmits a patrol execution instruction to the storage node which manages the primary slice of the segment for which the patrol is to be executed.

The slice management information group-storing section 520 is a storage device for storing the slice management information collected from the storage nodes 100, 200, 300, and 400. For example, part of the storage area of the RAM 502 in the control node 500 is used as the slice management information group-storing section 520.

The storage node 100 includes a data access section 130, a data management section 140, and a slice management information storing section 150.

The data access section 130 accesses data stored in the storage device 110 in response to a request from the access node 600. Specifically, when a data-reading request from the access node 600 is received, the data access section 130 acquires the data which is specified by the reading request from the storage device 110, and sends the same back to the access node 600. Further, when a data write request is received from the access node 600, the data access section 130 stores the data contained in the write request in the storage device 110.

Further, the data access section 130 carries out a media check for detecting generation of a bad block (bad sector). A method of the media check will be described hereinafter in detail. The data access section 130 forms essential parts of the data-checking unit and the data-reading/writing unit.

The data management section 140 manages the data stored in the storage device 110. Specifically, the data management section 140 performs the patrol for data stored in the storage device 110 according to the instruction from the control node 500. In performing the patrol, the data management section 140 transmits a checking request massage to the other storage node which manages the secondary slice associated with the primary slice to be checked. Further, upon reception of a checking request message from another storage node, the data management section 140 performs the patrol for data stored in a slice specified in the message.

Further, the data management section 140 transmits slice management information stored in the slice management information-storing section 150 to the logical volume management section 510 in response to a slice management information acquisition request from the logical volume management section 510.

The slice management information-storing section 150 is a storage device for storing slice management information. For example, part of the storage area in the RAM 102 is used as the slice management information-storing section 150.

The slice management information stored in the slice management information-storing section 150 is stored in the storage device 110 when the system is shut down, and is read into the slice management information-storing section 150 when the system is started.

The other storage nodes 200, 300, and 400 have the same functions as those of the storage node 100. That is, the storage node 200 includes a data access section 230, a data management section 240, and a slice management information-storing section 250. The storage node 300 includes a data access section 330, a data management section 340, and a slice management information-storing section 350. The storage node 400 includes a data access section 430, a data management section 440, and a slice management information-storing section 450. Each of the elements in the storage nodes 200, 300, and 400 has the same function as that of each of the elements having the same name in the storage node 100.

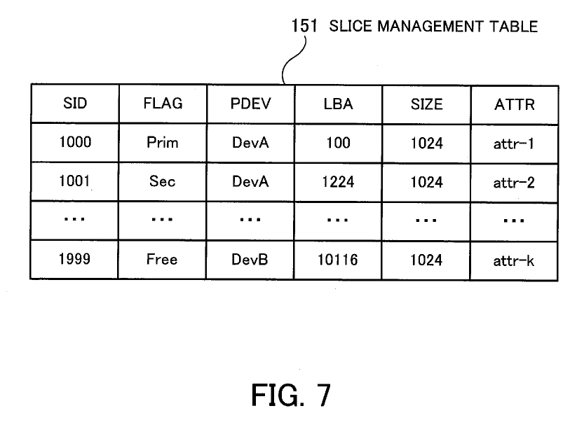

FIG. 7 illustrates an example of a data structure of slice management information.

The slice management information stored in the slice management information-storing section 150 is stored in a tabular form.

A slice management table 151 includes columns of SID (slice ID), FLAG, PDEV, LBA, SIZE, and ATTR, and pieces of information arranged in a row in the slice management table 151 are associated with each other.

The column of SID stores slice IDs each of which uniquely identifies a slice.

The column of FLAG stores flags acquired from respective areas managing slices. The flags are classified into “Prim” (P), “Sec” (S), and “Free” (F). “Prim” means that data exists, and the slice storing the data is a primary slice, and “Sec” means that data exists, and the slice for storing the data is a secondary slice. “Prim” and “Sec” are hereinafter also referred to as “data-stored”. “Free” means that no data does exist. “Free” is hereinafter referred to as “data-free”.

The column of PDEV stores respective names of devices where associated slices exists.

The column of LBA stores slice start positions (start blocks).

The column of SIZE stores slice sizes (numbers of blocks).

The column of ATTR stores the other attributes of each slice (e.g. information on time of access to an associated slice ID).

A similar slice management table is stored in each of the slice management information-storing section 250, 350, and 450 of the other storage nodes 200, 300, and 400.

The control node 500 collects slice management information from each of the storage nodes 100, 200, 300, and 400 when the system is started, and stores the collected information in the slice management information group-storing section 520.

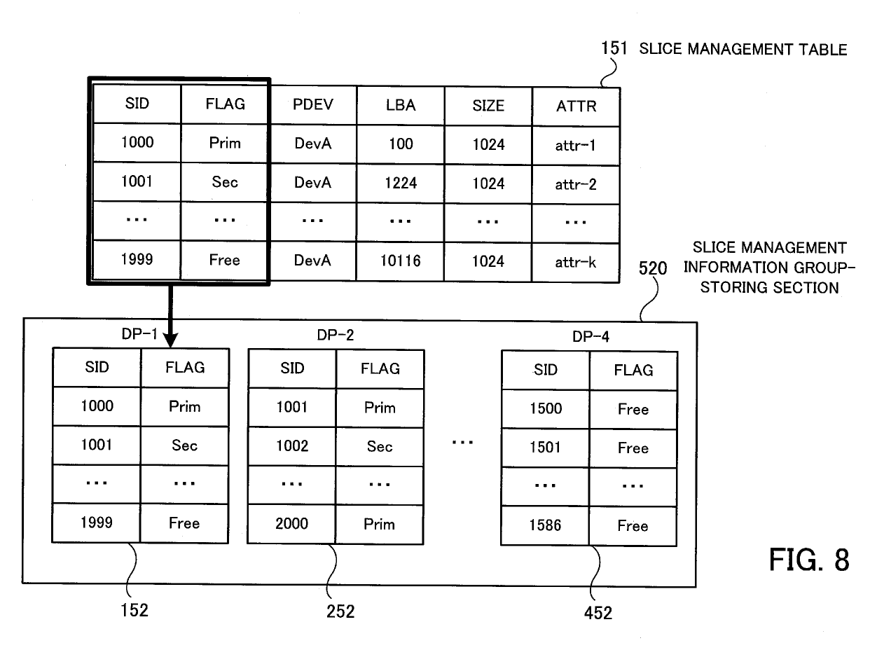

FIG. 8 illustrates an example of a data structure of the slice management information group-storing section.

The slice management information group-storing section 520 stores pieces of partial information 152, 252, 352, and 452 required for a media check, out of the collected slice management information. The partial information 352 is not shown in FIG. 8. The partial information 152 is acquired from the storage node 100. The partial information 252 is acquired from the storage node 200. The partial information 352 is acquired from the storage node 300. The partial information 452 is acquired from the storage node 400.

In the distributed storage system having the above-described structure, the data access sections 130, 230, 330, and 430 perform a media check for the storage nodes 100, 200, 300, and 400, respectively. The media check for the storage nodes 100, 200, 300, and 400 can be carried out by one of the following two methods.

### <Media Check Method A>

In a media check method A, each of the data access section 130, 230, 330, and 430 independently carries out a media check for the associated one of the storage nodes 100, 200, 300, and 400. Hereafter, a description will be given of the media check for the storage node 100 as a representative.

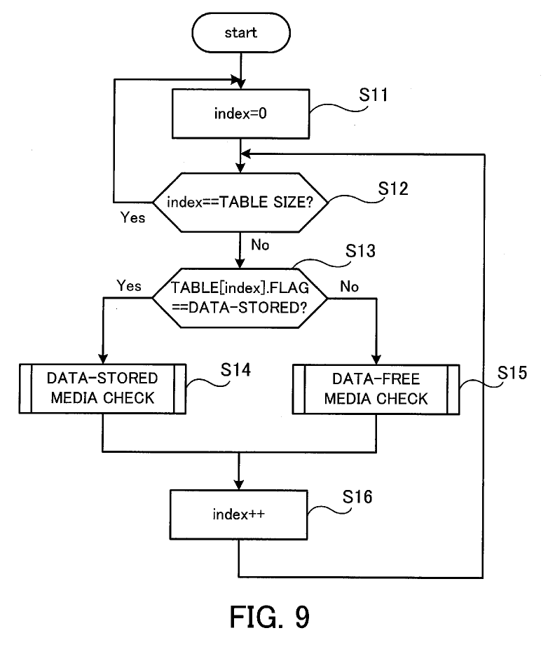

FIG. 9 is a flowchart of a media check process based on the media check method A.

First, an index provided for use as a parameter is initialized to a value 0 (step S11).

Next, it is determined whether or not a value of the index is equal to the number (table size) of slices stored in the slice management table 151 (step S12).

If the value of the index is equal to the number of the slices (Yes to the step S12), the process returns to the step S11 for subsequent repeated execution of the process.

If the value of the index is not equal to the number of slices, i.e. the value of the index is less than the number of the slices (No to the step S12), it is determined whether or not a flag indicative of “data-stored” is stored in a box of the column of FLAG associated with a slice ID corresponding to the value of the index (step S13).

If the flag indicative of “data-stored” is stored (Yes to the step S13), a data-stored media check is carried out on the slice having the above-mentioned slice ID (step S14). After the data-stored media check is terminated, the index is incremented by one (step S16). The process proceeds to the step S12 for subsequent repeated execution of the process. On the other hand, if the flag indicative of “data-stored” is not stored (No to the step S13), a data-free media check is carried out on the slice having the associated slice ID (step S15). After the data-free media check is terminated, the index is incremented by one (step S16). The process proceeds to the step S12 through the processing of S16 for subsequent repeated execution of the process.

Although in the present embodiment, an example in which the media check is continuously executed (example in which in the case of Yes to the step S12, the process returns to the step S11 to continue the operation) is described, this is not limitative, but, for example, if the value of the index becomes equal to the number of slices, the operation may be terminated, and when load on the CPU also responsible for other processes becomes not more than a predetermined value, the operation may be restarted.

Next, a description will be given of the data-stored media check.

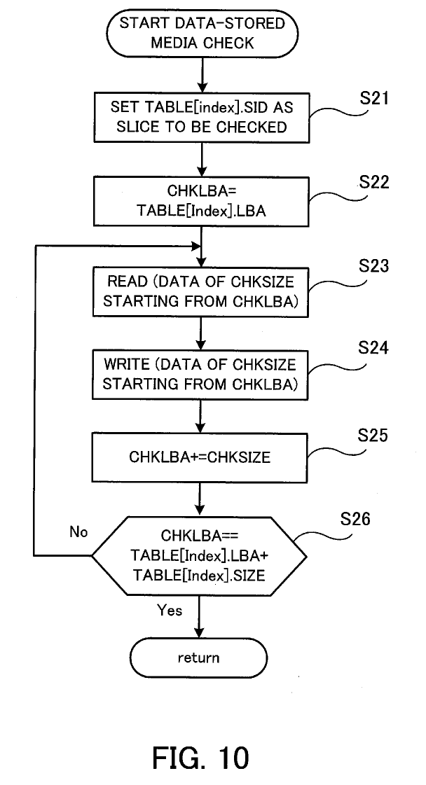

FIG. 10 is a flowchart of a media check process for a data-stored slice.

First, the slice ID corresponding to the value of the index on the slice management table 151 is set as a slice to be checked (step S21).

Next, a value in a box of the column of LBA associated with the slice to be checked is substituted into CHKLBA (LBA for checking) provided as a variable (step S22).

Next, data stored in blocks starting from the value of CHKLBA and corresponding in number to a variable CHKSIZE provided in a manner associated with SIZE in the slice management table 151 is read (step S23). For example, in the case of a slice ID “1000” in FIG. 7, it is required to check data stored in 1024 blocks starting from a 100th block, after all. Although all data in the 1024 blocks may be read at the same time, the variable CHKSIZE may be set to a divisor of 1024, in view of other factors, such as load. The variable CHKSIZE may be set to 128 or 256, for example.

Next, the read data is written into the slice to be checked, again (step S24).

Next, a value obtained by adding the value of CHKSIZE to the value of CHKLBA is set as a new value of CHKLBA (step S25).

Next, it is determined whether or not the value of CHKLBA is equal to the sum of the value stored in the box of the column of LBA associated the slice to be checked and the value stored in the box of the column of SIZE associated with the same (step S26).

If the value of CHKLBA is not equal to the sum of the two (No to the step S26), the process proceeds to the step S23 for subsequent repeated execution of the process.

On the other hand, if the value of CHKLBA is equal to the sum of the two (Yes to the step S26), the data-stored media check process is terminated.

Next, a description will be given of the data-free slice media check.

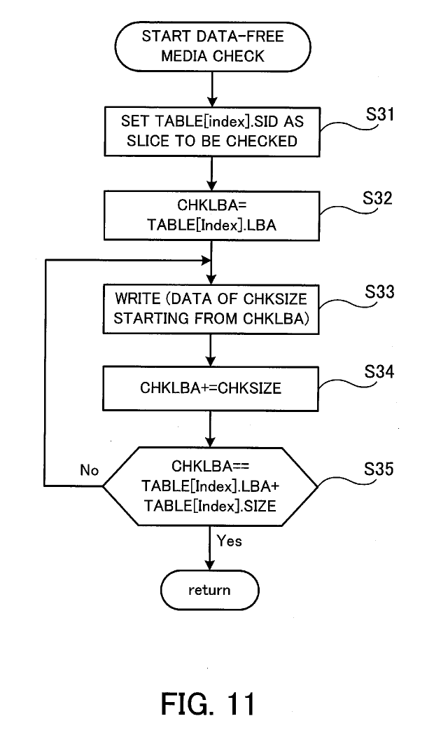

FIG. 11 is a flowchart of a media check process for a data-free slice.

Steps S31 and S32: Similar processing as executed in each corresponding one of the steps S21 and S22 is executed.

Next, an initial value (NULL value or the like) of data is written into the slice to be checked (step S33).

Steps S34 and S35: Similar processing as executed in each corresponding one of the steps S25 and S26 is executed.

### <Media Check Method B>

A media check method B is different from the media check method A in that the control node 500 issues an instruction to perform the media check, and the data access sections 130, 230, 330, and 430 perform a media check according to this instruction.

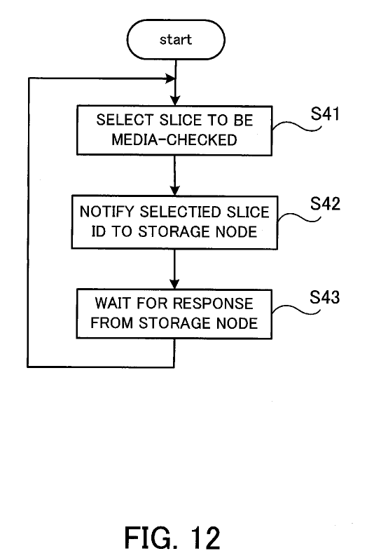

FIG. 12 is a flowchart of a media check process based on the media check method B, which is executed by the control node.

First, the control node 500 selects a slice on which the media check is to be performed (step S41).

Next, the control node notifies the selected slice ID to a storage node associated with a storage device including the selected slice (step S42).

Thereafter, a response from the notified storage node is waited for a predetermined time period (step S43).

The control node 500 repeats the operations of the above-mentioned steps S41 to S43.

Next, a description will be given of a media check performed by the notified storage node.

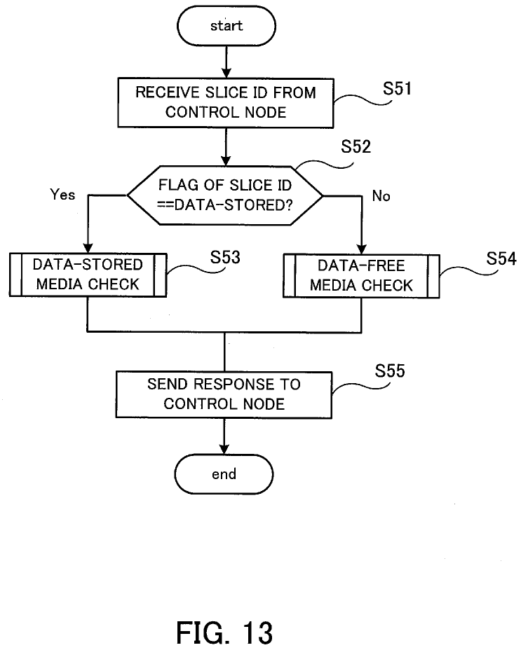

FIG. 13 is a flowchart of the media check process executed by the notified storage node.

First, the slice ID transmitted by the control node 500 is received (step S51).

Next, it is determined whether or not a flag indicative of “data-stored” is stored in a box of the column of FLAG associated with the received slice ID (step S52).

If the flag indicative of “data-stored” is stored in the column of FLAG (Yes to the step S52), the data-stored media check is carried out on the slice having the received slice ID (step S53). After the media check is terminated, a response is returned to the control node 500 (step S55). This completes the media check.

On the other hand, if the flag indicative of “data-stored” is not stored in the column of FLAG (No to the step S52), the data-free media check is carried out on the slice having the received slice ID (step S54). When the media check is terminated, a response is returned to the control node 500 (step S55). Thus, the media check is terminated.

By the way, in the distributed storage system, if a bad block is found by the media check, different processes are carried out in coping with the bad block according to the “data-stored” and the “data-free”.

In a case of the data-stored slice, if a bad block is detected as a result of reading, the bad block is reported. If the data contained in the bad block can be recovered within the storage device, the storage device reallocates a block to the data, and recovers the data. If the data cannot be recovered within the storage device, the data is recovered by carrying out the above-described patrol. If a bad block is not detected as a result of reading, the read data is written into the slice as it is. This is for the purpose of checking a disk or part of the disk which is in charge of a mirror region (in a case of the RAID 1) or a parity region (in a case of the RAID 5) which cannot be checked by reading. If a bad block is generated in the mirror region or the parity region by writing, for example, the reallocation of blocks can be caused.

Also in a case of the data-free slice, if a bad block is found by writing the initial value of data, reallocation of blocks can be caused.

As described above, according to the distributed storage system of the present embodiment, when each of the data access sections 130, 230, 330, and 430 accesses data stored in an associated one of the storage devices 110, 210, 310, and 410, reading and writing are performed on a data-stored slice thereof, and only writing is performed on a data-free slice without reading. This makes it possible to improve the efficiency of checking of the entire system, or reduce the electric power consumption.

Further, according to the media check method A, the storage node itself is capable of performing a media check without waiting for an instruction from the control node 500. This makes it possible to simplify the process executed by the system.

Further, according to the media check method B, it is possible to perform the media check in consideration of the entire system according to purposes, such as checking of primary slices or secondary slices of one logical volume, to which importance is attached. Further, by managing the media check conditions of the storage nodes 100, 200, 300, and 400 by the control node 500, it is possible to operate each storage node in consideration of the system conditions with ease. For example, if load on the entire system is heavy due to a certain process being executed, it is possible to reduce the load on the system by issuing an instruction to refrain from performing a media check on one or more of the storage nodes.

Although the computer-readable storage medium storing storage management program, storage management method, and the storage management apparatus according to the present invention have been described based on the embodiment illustrated in the drawings, this is not limitative, but the configuration of each section can be replaced by a desired configuration having similar functions. Further, any other desired construction or processes may be added to the present invention.

Further, the present invention may be formed by a combination of desired two or more configurations (features) out of the above-described embodiment.

It should be noted that although in the present embodiment, the case where the media check is applied to the distributed storage system has been described, this is not limitative, it is also possible to apply the media check to a volume having no redundancy (normal physical disk or JBOD (Just a Bunch Of Disks) or the like). In this case, in the case of a data-stored slice, it is preferable to configure the system such that if a bad block is detected as a result of reading, a report of the detection result is made. In the case of a data-free slice, it is preferable to configure the system such that a null value or the like is written, and if a bad block is detected, a block is allocated to a different area other than the bad block. Although the null value may be written after reading, it is not necessary to perform reading.

It should be noted that it is possible to realize the above-described function of processing by a computer. In this case, a program in which content of processing of function to be included in each of the storage nodes 100, 200, 300, and 400 is written is provided. By carrying out the program by the computer, the above-described function of processing is realized on the computer. The program in which the content of processing is written can be recorded in a record medium which is capable of being read by the computer. Examples of the record medium which is capable of being read by the computer include a magnetic recording system, an optical disk, a magnetooptical medium, a semiconductor memory or the like. Examples of the magnetic recording system include a hard disk device (HDD), a flexible disk (FD), a magnetic tape. Examples of the optical disk include a DVD (Digital Versatile Disc), a DVD-RAM (Random Access Memory) a CD-ROM (Compact Disc Read Only Memory), a CD-R (Recordable)/RW (ReWritable). Examples of the magnetooptical medium include an MO (Magneto-Optical disc).

In case of distributing programs, for example, portable record mediums, such as DVD, CD-ROM or the like in which the program is recorded are marketed. Further, it is also possible to store the program in a storing device of a server computer, and transfer the program from the server computer to the other computer via a network.

The computer which carries out the program stores, for example, the program which is recorded in the portable record medium, or is transferred from the server computer in the storing device thereof. Then, the computer reads out the program from the storing device thereof, and carries out the processes according to the program. It should be noted that the computer is also capable of directly reading out the program from the portable record medium, and carrying out the processes according to the program. Further, the computer is also capable of carrying out the processes according to the program which is received, each time the program is transferred from the server computer.

According to the present invention, since the data read operation is not performed on a data-storing area in which data does not exist at the time of a read/write check, it is possible to check rapidly and efficiently. Further, it is possible to reduce load of checking, whereby this makes it possible to reduce the electric power consumption.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has (have) been described in detail, it should be understood that various changes, substitutions, and alterations could be made hereto without departing from the spirit and scope of the invention.

What is claimed is:

1. A computer-readable storage medium storing a storage management program for performing a read/write check on each of a plurality of data-storing areas of a storage device,
wherein the storage management program causes a computer which is formed by a storage node that performs reading/writing of the data in the storage device to function as;
a data-checking unit configured to determine whether or not the data exits, by referring to a flag provided in each data-storing area; and
a data-reading/writing unit configured to perform only an operation of writing the data into the data-storing area in which the data does not exist, and perform operations of reading and writing the data from and into the data-storing area in which the data exists.

2. The computer-readable storage medium according to claim 1, wherein the computer is caused to function as a flag management information group-storing unit configured to collectively manage the flags provided for the data-storing areas, respectively, and
wherein the data-checking unit determines whether or not the data exists by referring to the flag management information group-storing unit.

3. The computer-readable storage medium according to claim 1, wherein the data-checking unit operates according to an instruction from a management computer which manages the computer.

4. The computer-readable storage medium according to claim 3, wherein when the management computer has a plurality of the computers connected thereto, the management computer includes an information storing unit configured to collectively manage relationships between the data-storing areas and the flags, in each computer.

5. A storage management method in which a computer performs a read/write check in a plurality of data-storing areas of a storage device,
wherein the computer which is formed by a storage node that performs reading/writing of the data in the storage device:
determines whether or not the data exits, by referring to a flag provided in each data-storing area; and
performs only an operation of writing the data into the data-storing area in which the data does not exist, and performs operations of reading and writing the data from and into the data-storing area in which the data exists.

6. The storage management method according to claim 5, wherein the computer collectively manages the flags provided for the data-storing areas, respectively, and determines whether or not the data exists by referring to the flags collectively managed.

7. The storage management method according to claim 5, wherein the computer operates according to an instruction from a management computer which manages the computer.

8. The storage management method according to claim 7, wherein when the management computer has a plurality of the computers connected thereto, the management computer collectively manages relationships between the data-storing areas and the flags, in each computer.

9. A storage management apparatus that performs a read/write check on each of a plurality of data-storing areas of a storage device, and is formed by a storage node that performs reading/writing of the data in the storage device, comprising:
a data-checking unit configured to determine whether or not the data exits, by referring to a flag provided in each data-storing area; and
a data-reading/writing unit configured to perform only an operation of writing the data into the data-storing area in which the data does not exist, and perform operations of reading and writing the data from and into the data-storing area in which the data exists.

10. The storage management apparatus according to claim 9, further comprising a flag management information group-storing unit configured to collectively manage the flags provided for the data-storing areas, respectively,
wherein said data-checking unit determines whether or not the data exists by referring to the flag management information group-storing unit.

11. The storage management apparatus according to claim 9, wherein the data-checking unit operates according to an instruction from a management computer which manages the storage management apparatus.

12. The storage management apparatus according to claim 11, wherein when the management computer has a plurality of the storage management apparatuses connected thereto, the management computer includes an information storing unit configured to collectively manage relationships between the data-storing areas and the flags, in each storage management apparatus.
